(19) United States
(12) Patent Application Publication
(10) Pub. No.: US 2026/0155112 A1
(43) Pub. Date: Jun. 4, 2026

(54) ELECTRONIC APPARATUS AND CONTROLLING METHOD THEREOF

(71) Applicant: Samsung Electronics Co., Ltd., Suwon-si (KR)

(72) Inventors: Dongjun KIM, Suwon-si (KR); Eungsik Yoon, Suwon-si (KR)

(73) Assignee: Samsung Electronics Co., Ltd., Suwon-si (KR)

(21) Appl. No.: 19/257,017

(22) Filed: Jul. 1, 2025

Related U.S. Application Data
(63) Continuation of application No. PCT/KR2025/007347, filed on May 29, 2025.

(30) Foreign Application Priority Data
Sep. 4, 2024 (KR) 10-2024-0120348

(51) Int. Cl. G09G 5/36

(52) U.S. Cl. CPC G09G 3/344; G06F 1/3203; G06F 1/3265; G09G 2330/021

(57) ABSTRACT

An electronic apparatus includes, memory storing one or more instructions; a communication interface; a display; and at least one processor including processing circuitry, wherein the one or more instructions, when executed by the at least one processor individually or collectively, cause the electronic apparatus to control the display to display a first image in a first mode; control, based on the first mode being changed to a second mode based on a first user input, the display to update the first image in the first mode after a first time; and control, based on the first mode being changed to a third mode based on a second user input, the display to update the first image in the first mode after a second time, and wherein the communication interface is deactivated in the second mode, and activated in the third mode.

### CROSS-REFERENCE TO RELATED APPLICATIONS

This application is a bypass continuation of International Application No. PCT/KR2025/007347, filed on May 29, 2025, which is based on and claims priority to Korean Patent Application No. 10-2024-0120348, filed on Sep. 4, 2024, in the Korean Intellectual Property Office, the disclosures of which are incorporated by reference herein in their entireties.

### BACKGROUND

### 1. Field

The disclosure relates to an electronic apparatus and a controlling method thereof, and more particularly to an electronic apparatus that displays an image using electronic ink and a controlling method thereof.

### 2. Description of Related Art

Electronic apparatuses of various types are being developed with the development of electronic technology. User convenience has improved recently due to displays of various types being supplied.

For example, recently, display apparatuses included with ePaper displays are being supplied. Because ePaper displays consume little power, the display apparatuses may be widely used without being connected to external power.

Notwithstanding, managing power consumption of display apparatuses with ePaper displays remains an issue.

### SUMMARY

Provided are an electronic apparatus that may manage power using one or more modes, such as a power-saving mode, a communication standby mode, or a normal mode, and a controlling method thereof.

According to an aspect of the disclosure, an electronic apparatus includes, memory storing one or more instructions; a communication interface; a display; and at least one processor including processing circuitry, wherein the one or more instructions, when executed by the at least one processor individually or collectively, cause the electronic apparatus to control the display to display a first image in a first mode; control, based on the first mode being changed to a second mode based on a first user input, the display to update the first image in the first mode after a first time; and control, based on the first mode being changed to a third mode based on a second user input, the display to update the first image in the first mode after a second time, and wherein the communication interface is deactivated in the second mode, and activated in the third mode.

The first mode may be a normal mode, the second mode may be a power saving mode, and the third mode may be a communication standby mode.

The one or more instructions, when executed by the at least one processor individually or collectively, may cause the electronic apparatus to change, based on the first user input being received, from the first mode to the second mode; change, based on the first time being reached in the second mode being identified, the second mode to the first mode; control the display to update the first image in the first mode; and change from the first mode to the second mode.

The one or more instructions, when executed by the at least one processor individually or collectively, may cause the electronic apparatus to change, based on the second user input being received, from the first mode to the third mode; change, based on the second time being reached in the third mode, the third mode to the first mode; control the display to update the first image in the first mode; and change from the first mode to the third mode.

The display may include an e-Paper display.

The e-Paper display may include electronic ink including charged particles, and wherein the one or more instructions, when executed by the at least one processor individually or collectively, may cause the electronic apparatus to: initialize an arrangement of the charged particles, and control the e-Paper display to update the first image by realigning the arrangement of the charged particles based on the first image.

The communication interface may include at least one from among a Bluetooth interface or a Wi-Fi interface, and wherein the third mode activates at least one from among the Bluetooth interface or the Wi-Fi interface.

The one or more instructions, when executed by the at least one processor individually or collectively, may cause the electronic apparatus to store, based on a control command for image changing being received from an external device while operating in the third mode, the control command; change, based on the second time being reached in the third mode, the third mode to the first mode; control the display to change the first image to a second image based on the control command in the first mode; and change from the first mode to the second mode or the third mode.

The electronic apparatus further may include a low-power timer, and wherein the one or more instructions, when executed by the at least one processor individually or collectively, may cause the electronic apparatus to determine whether the first time and the second time are reached using the low-power timer.

The electronic apparatus further may include a power unit including at least one from among a power controller, a rechargeable battery, a power adaptor, a harvesting Power Management Integrated Circuit (PMIC), or a solar battery, wherein the rechargeable battery may be connected with at least one from among the power adaptor, the harvesting PMIC, or the solar battery, and wherein the one or more instructions, when executed by the at least one processor individually or collectively, may cause the electronic apparatus to supply power of the rechargeable battery to the low-power timer through the power controller in the second mode and the third mode.

According to an aspect of the disclosure, a controlling method of an electronic apparatus including a display and a communication interface, the controlling method including: displaying a first image in a first mode; updating, based on the first mode being changed to a second mode based on a first user input, the first image in the first mode after a first time; and updating, based on the first mode being changed to a third mode based on a second user input, the first image in the first mode after a second time, wherein the communication interface is deactivated in the second mode, and activated in the third mode.

The first mode may be a normal mode, the second mode may be a power saving mode, and the third mode may be a communication standby mode.

The controlling method may further include changing, based on the first user input being received, from the first mode to the second mode; changing, based on the first time being reached in the second mode, the second mode to the first mode; updating the first image in the first mode; and changing from the first mode to the second mode.

The controlling method may further include changing, based on the second user input being received, from the first mode to the third mode; changing, based on the second time being reached in the third mode, the third mode to the first mode; updating the first image in the first mode; and changing from the first mode to the third mode.

The display may include an e-Paper display.

The e-Paper display may include electronic ink including charged particles, and wherein the updating the first image may include initializing an arrangement of the charged particles, and updating the first image by realigning the arrangement of the charged particles based on the first image.

The communication interface may include at least one from among a Bluetooth interface or a Wi-Fi interface, and wherein the third mode activates at least one from among the Bluetooth interface or the Wi-Fi interface.

The controlling method may further include storing, based on a control command for image changing being received from an external device while operating in the third mode, the control command; changing, based on the second time being reached in the third mode, the third mode to the first mode; controlling the display to change the first image to a second image based on the control command in the first mode; and changing from the first mode to the second mode or the third mode.

The electronic apparatus may include a low-power timer, and wherein the controlling method further may include determining whether the first time and the second time are reached based on an output of the low-power timer.

According to an aspect of the disclosure, a non-transitory computer-readable recording medium having one or more instructions recorded thereon, that, when executed by an electronic apparatus including a display and a communication interface individually or collectively, cause the electronic apparatus to: control the display to display a first image in a first mode; control, based on the first mode being changed to a second mode based on a first user input, the display to update the first image in the first mode after a first time; and control, based on the first mode being changed to a third mode based on a second user input, the display to update the first image in the first mode after a second time, wherein the communication interface may be deactivated in the second mode, and activated in the third mode.

### BRIEF DESCRIPTION OF DRAWINGS

The above and other aspects, features, and advantages of certain embodiments of the present disclosure are more apparent from the following description taken in conjunction with the accompanying drawings, in which:

FIG. 1 is a diagram illustrating an electronic apparatus displaying an image according to an embodiment;

FIG. 2 is a block diagram illustrating an electronic apparatus according to an embodiment;

FIG. 3 is a block diagram illustrating a detailed configuration of the electronic apparatus of FIG. 2 according to an embodiment;

FIG. 4 is a diagram illustrating an operation for changing a mode by using a physical button according to an embodiment;

FIG. 5 is a diagram illustrating an operation in which a mode is automatically changed according to an embodiment;

FIG. 6 is a diagram illustrating an operation for changing a mode through an application command according to an embodiment;

FIG. 7 is a diagram illustrating an electronic apparatus operating in a power-saving mode according to an embodiment;

FIG. 8 is a diagram illustrating an electronic apparatus operating in a communication standby mode according to an embodiment;

FIG. 9 is a diagram illustrating an electronic apparatus operating in a communication standby mode according to an embodiment;

FIG. 10 is a diagram illustrating an image updating (or changing) operation according to an embodiment;

FIG. 11 is a diagram illustrating an image updating (or changing) operation in a power-saving mode and a normal mode according to an embodiment;

FIG. 12 is a diagram illustrating an image updating (or changing) operation in a power-saving mode and a normal mode according to an embodiment;

FIG. 13 is a diagram illustrating an operation for performing a control command received from an external device according to an embodiment;

FIG. 14 is a diagram illustrating an image updating (or changing) operation in a communication standby mode and a normal mode according to an embodiment;

FIG. 15 is a diagram illustrating an operation for performing a control command received from an external device according to an embodiment;

FIG. 16 is a diagram illustrating an operation for performing a control command received from an external device according to an embodiment;

FIG. 17 is a diagram illustrating an operation for performing a control command in a power-saving mode, a communication standby mode, and a normal mode according to an embodiment;

FIG. 18 is a diagram illustrating an operation for controlling a LAN interface according to an embodiment;

FIG. 19 is a diagram illustrating information associated with a physical button according to an embodiment;

FIG. 20 is a diagram illustrating an operation for displaying a battery remaining amount according to an embodiment;

FIG. 21 is a diagram illustrating an operation for displaying an image including a charging guide UI according to an embodiment;

FIG. 22 is a diagram illustrating an operation for displaying an image including a charging guide UI according to an embodiment;

FIG. 23 is a diagram illustrating an operation for displaying an image including a charging guide UI according to an embodiment;

FIG. 24 is a diagram illustrating an operation for displaying an image including a charging guide UI according to an embodiment; and

FIG. 25 is a diagram illustrating a controlling method of an electronic apparatus according to an embodiment.

### DETAILED DESCRIPTION

The embodiments described in the disclosure, and the configurations shown in the drawings, are only examples of embodiments, and various modifications may be made without departing from the scope and spirit of the disclosure.

The disclosure will be described in detail below with reference to the accompanying drawings.

Terms used in describing embodiments of the disclosure are terms selected that are currently widely used considering their function herein. The terms may change depending on intention, legal or technical interpretation, emergence of new technologies, and the like of those skilled. In certain cases, there may be terms arbitrarily selected, and the meaning of the term will be disclosed in detail in the relevant description. The terms used herein are not to be understood as its designation but based on the meaning of the term and the overall context of the disclosure.

Expressions such as “have,” “may have,” “include,” and “may include” are used to designate a presence of a corresponding characteristic (e.g., elements such as numerical value, function, operation, or component), and not to preclude a presence or a possibility of additional characteristics.

The expression at least one of A and/or B is to be understood as indicating any one of “A” or “B” or “A and B”.

Expressions such as “1st”, “2nd”, “first”, or “second” used in the disclosure may limit various elements regardless of order and/or importance, and may be used to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

A singular expression includes a plural expression, unless otherwise indicated. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used in the embodiments herein perform at least one function or operation, and may be implemented with a hardware or software, or implemented with a combination of hardware and software. A plurality of “modules” or a plurality of “parts”, except for a “module” or a “part” which may be implemented with hardware, may be integrated in at least one module and implemented as at least one processor.

The term “user” may refer to a person using an electronic apparatus or an apparatus (e.g., artificial intelligence electronic apparatus) using the electronic apparatus.

The disclosure will be described in greater detail below with reference to the accompanied drawings.

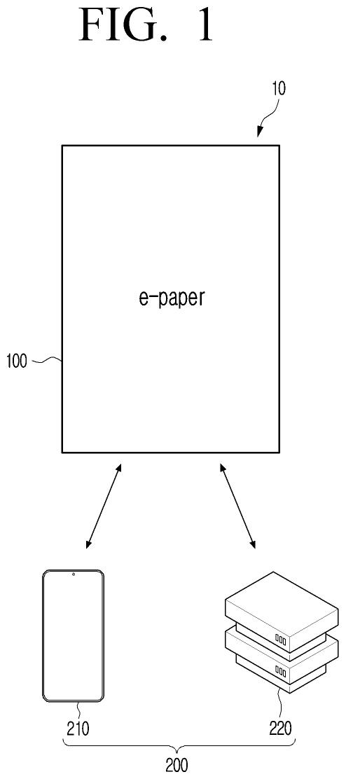

FIG. 1 is a diagram illustrating an electronic apparatus 100 displaying an image according to an embodiment.

Referring to FIG. 1, the electronic apparatus may be an apparatus which displays an image. The electronic apparatus 100 may be a display apparatus including panels for displaying an image.

The electronic apparatus 100 may be communicatively connected with an external device 200. The electronic apparatus 100 may receive an image or receive a control command from the external device 200.

The electronic apparatus 100 may display an image received from the external device 200. The electronic apparatus 100 may perform a control operation based on the control command received from the external device 200.

The electronic apparatus 100 may operate in a plurality of modes. The electronic apparatus 100 may operate in one mode from among a first mode, a second mode, or a third mode. The first mode may be a a normal mode, the second mode may be a power-saving mode, and the third mode may be a communication standby mode.

The third mode may be a power-saving mode for saving power by supplying power to only a pre-set module.

The second mode may be a communication standby mode for additionally supplying power to a module performing a communication function in a module supplied in the power-saving mode. The communication standby mode may be described as a network standby mode, an external communication mode, or the like.

The first mode may be a normal mode in which power is supplied to all modules included in the electronic apparatus 100. The normal mode may be a mode in which power is supplied to a main processor.

In an example, the electronic apparatus 100 may be an electronic-Paper (e-Paper). The electronic apparatus 100 may be described as an electronic paper, an electronic book, an e-Paper display, an e-Paper apparatus, an e-Paper device, or the like.

The electronic apparatus 100 may display an image using electronic ink. The electronic ink may include color particles (e.g., black and white particles). The electronic apparatus 100 may display an image using microcapsules including electronic ink. The electronic ink included in the microcapsules may include particles of a first color (e.g., white) having a positive charge, and particles of a second color (e.g., black) having a negative charge. The electronic apparatus 100 may display an image by electrically controlling the microcapsules.

According to an embodiment, the electronic apparatus 100 may display various colors using the microcapsules including the white particles and the black particles and a color filter.

The electronic apparatus 100 may apply voltage to a display module and control the particles of the first color of the electronic ink included in the microcapsules to be positioned at an upper side of a panel or control the particles of the second color to be positioned at the upper side of the panel. Depending on which particles are positioned at the upper side, the image may be displayed.

The electronic apparatus 100 may apply voltage for disposing the particles based on an image pixel value. An operation for disposing the particles by applying voltage may be performed in the normal mode.

When particles are disposed by applying voltage, the electronic apparatus 100 may not have to apply additional voltage to continuously display an image. The electronic apparatus 100 may change the normal mode to the power-saving mode. The electronic apparatus 100 may operate in the power-saving mode while the image is displayed. The electronic apparatus 100 may apply voltage to a portion of the elements even in the power-saving mode. The electronic apparatus 100 may update the image for every pre-set time.

An image update may include an operation for displaying an image which is same as a previous image once again. The image update may include an operation for realigning an arrangement of the disposed particles. The electronic apparatus 100 may initialize the arrangement of the already disposed particles. The electronic apparatus 100 may align the arrangement of the initialized particles again based on the image pixel values. As a result, the electronic apparatus 100 may display the same image by performing an image update operation. Through the image update operation, the electronic apparatus 100 may prevent image sticking of e-Paper. The pre-set time may be changed according to user setting.

The electronic apparatus 100 may include one from among an ElectroPhoretic Display, an Electrowetting Display, or an Interferometric Modulator Display.

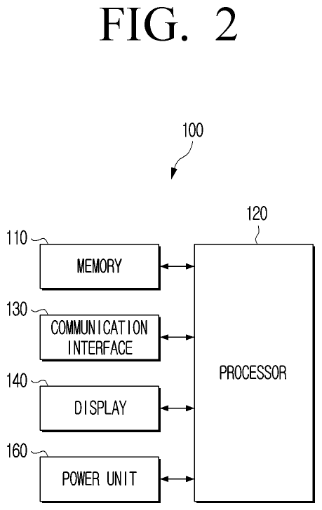

FIG. 2 is a block diagram illustrating the electronic apparatus 100 according to an embodiment.

Referring to FIG. 2, the electronic apparatus 100 may include a memory for storing instructions, a communication interface 130, a display 140, a power unit, and at least one processor 120 including processing circuitry.

The at least one processor 120 may operate in a plurality of modes. The plurality of modes may include at least one from among the power-saving mode, the communication standby mode, or the normal mode.

The power-saving mode may be a mode limiting power in order to perform only a pre-set function.

The communication standby mode may be a mode for additionally performing a communication function in the power-saving mode.

The normal mode may be a mode in which a plurality of functions performable in the electronic apparatus 100 is executed.

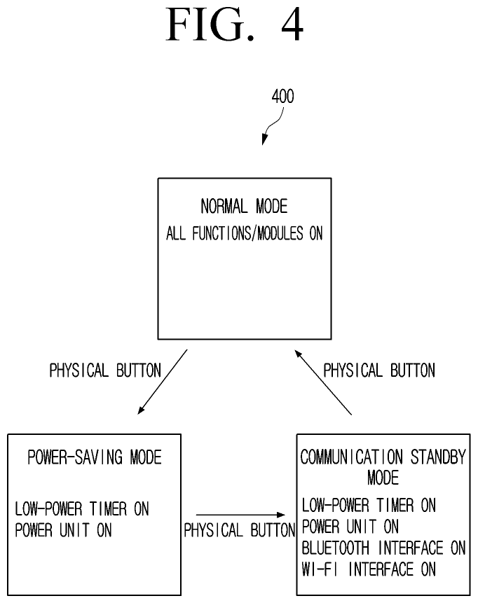

Descriptions for each of the power-saving mode, the communication standby mode, and the normal mode will be described in FIG. 4.

The at least one processor 120 may control the display 140 to display a first image in the normal mode.

While the electronic apparatus 100 is not displaying any image whatsoever, the at least one processor 120 may obtain a control command for displaying the first image. The at least one processor 120 may display the first image in the normal mode.

The at least one processor 120 may control, based on the normal mode being changed to the power-saving mode based on a first user input, the display 140 to update the first image in the normal mode after a first time. The expression of changing to a mode may be described as an expression of operating in a mode.

The at least one processor 120 may receive the first user input.

The first user input may indicate a user command for changing from the normal mode to the power-saving mode. In an example, the first user input may include an input of a user pressing a physical button of the electronic apparatus 100. In an example, the first user input may be received through an application of the external device 200. Additional descriptions associated with user inputs will be described in FIG. 4 to FIG. 6.

When the first user input is received, the at least one processor 120 may change from the normal mode to the power-saving mode. The at least one processor 120 may identify whether the first time is reached (or passed) in the power-saving mode.

When an event of reaching (or passing) the first time in the power-saving mode is identified, the at least one processor 120 may change the power-saving mode to the normal mode.

The at least one processor 120 may control the display 140 to update the first image in the normal mode. When the first image is updated, the at least one processor 120 may change from the normal mode the power-saving mode.

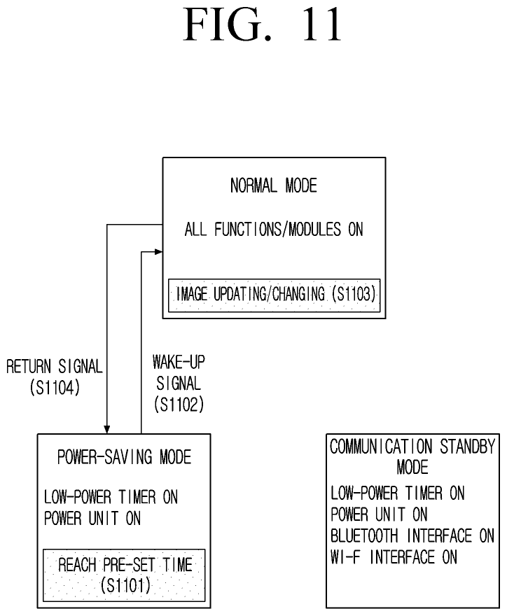

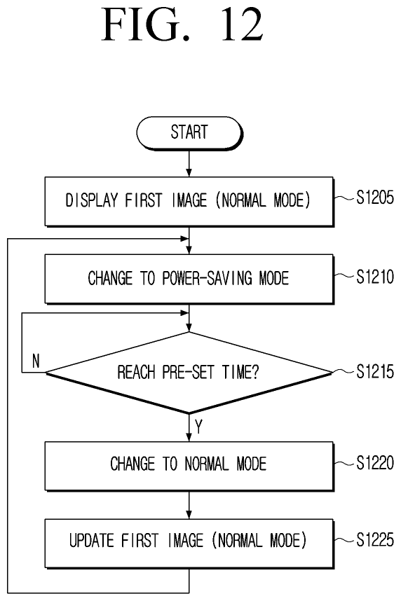

Descriptions associated with an embodiment of changing from the power-saving mode to the normal mode will be described in FIG. 11 to FIG. 12.

The at least one processor 120 may control, based on the normal mode being changed to the communication standby mode based on a second user input, the display 140 to update the first image in the normal mode after a second time.

The at least one processor 120 may receive the second user input.

The second user input may indicate a user command for changing from the normal mode to the communication standby mode. In an example, the second user input may include an input of the user pressing the physical button of the electronic apparatus 100. In an example, the second user input may be received through an application of the external device 200. Additional descriptions associated with the user inputs will be described in FIG. 4 to FIG. 6.

When the second user input is received, the at least one processor 120 may change from the normal mode to the communication standby mode. The at least one processor 120 may identify whether the second time is reached (or passed) in the communication standby mode.

When an event of reaching (or passing) the second time in the communication standby mode is identified, the at least one processor 120 may change the communication standby mode to the normal mode.

The at least one processor 120 may control the display 140 to update the first image in the normal mode. When the first image is updated, the at least one processor 120 may change from the normal mode the communication standby mode.

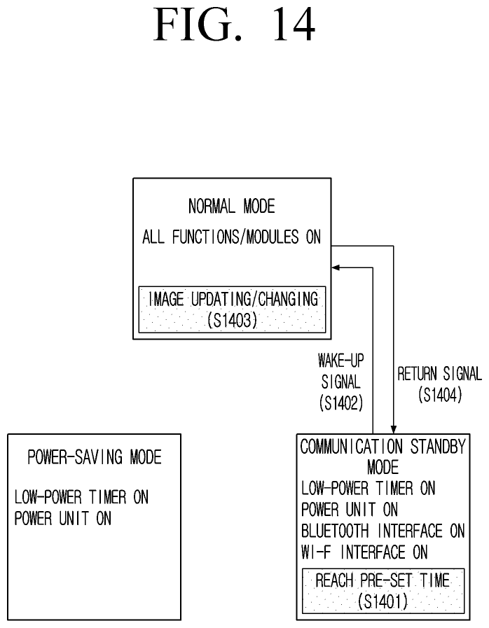

Descriptions associated with an embodiment of changing from the communication standby mode to the normal mode will be described in FIG. 14.

The first time may be described as a first threshold time, a first period, a first pre-set time, and the like.

The second time may be described as a second threshold time, a second period, a second pre-set time, and the like.

In an example, the first time and the second time may be different. The first time calculated (or computed) in the power-saving mode and the second time calculated (or computed) in the communication standby mode may be different.

In an example, the first time and the second time may be the same. The first time calculated (or computed) in the power-saving mode and the second time calculated (or computed) in the communication standby mode may be the same. The second time may be described as the first time.

With respect to descriptions of a plurality of drawings below, the first time and the second time described may not all mean the same concept. The above may be for differentiating different times from one another in the respective embodiments. Ordinal numbers described in the first time and the second time may be changed. With respect to the time applied when the embodiments are different, the first time may be described as a third time, and the second time may be described as a fourth time. In the description below, concept of time indicated first in each embodiment will be described as the first time, and the concept of time that follows secondly will be described as the second time for convenience of description in each embodiment.

If the concept of time is the same, the expression ‘first time’ or ‘second time’ may be maintained. Even if a portion of the embodiment is different, the same ordinal number time expression may be described. The expression of first time may be maintained identically for the concept of time applied in the power-saving mode, and the expression of second time may be maintained identically for the concept of time applied in the communication standby mode.

The communication interface 130 may be deactivated in the power-saving mode, and activated in the communication standby mode.

The power-saving mode may be a mode in which power is not supped to the communication interface 130. The communication standby mode may be a mode for supplying power to the communication interface 130. In the power-saving mode, information may not be received from the external device 200. In the communication standby mode, information may be received from the external device 200. In the communication standby mode, control commands received from the external device 200 may not be directly performed.

The display 140 may include an e-Paper display. The display 140 may include electronic ink including charged particles.

The at least one processor 120 may initialize an arrangement of the charged particles, and control the display 140 to update the first image by realigning the arrangement of the charged particles based on the first time. The description associated with the e-Paper has been described in FIG. 1.

The communication interface 130 may include at least one from among a Bluetooth interface 131 or a Wi-Fi interface 132. The communication standby mode may be a mode for activating at least one from among the Bluetooth interface 131 or the Wi-Fi interface 132.

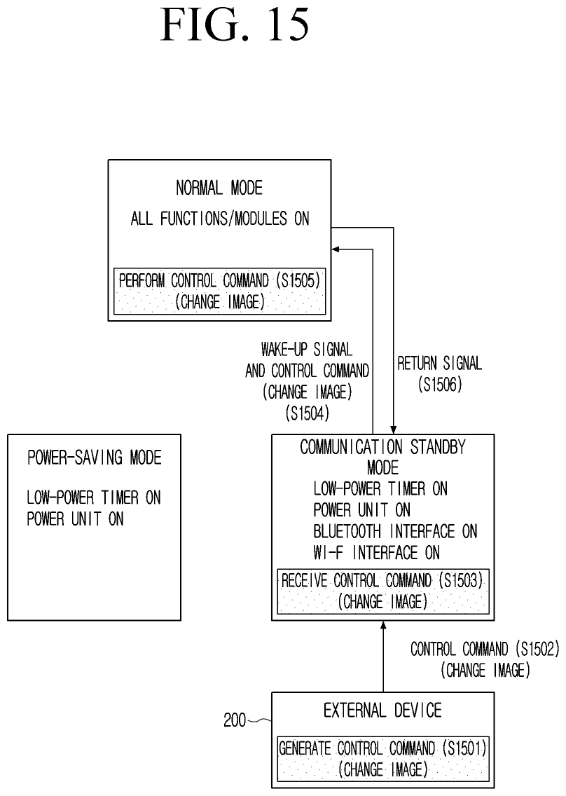

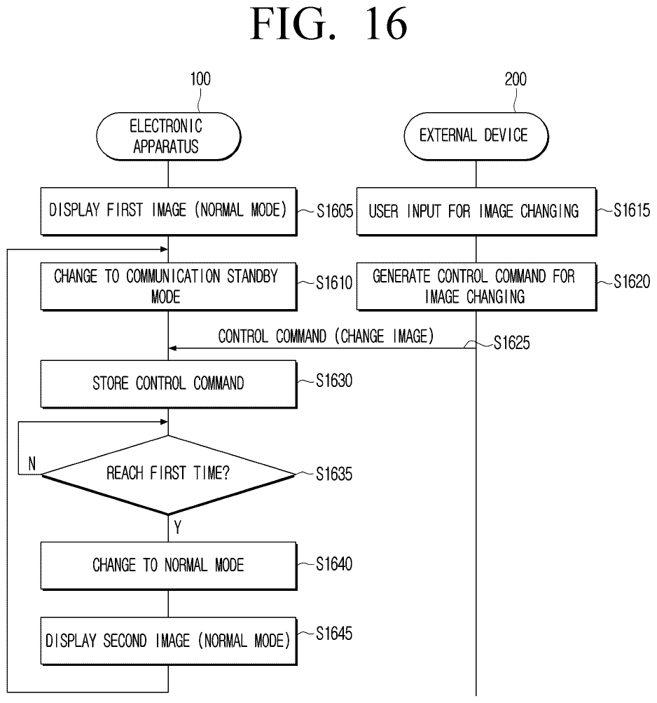

The at least one processor 120 may store, based on a control command for image changing being received from the external device while operating in the communication standby mode, the control command. The at least one processor 120 may change, based on an event of reaching (or passing) the second time in the communication standby mode being identified, the communication standby mode to the normal mode. The at least one processor 120 may control the display 140 to change the first image to a second image based on the control command in the normal mode. The at least one processor 120 may change from the normal model to the power-saving mode or the communication standby mode. Descriptions associated with the control commands received from the external device 200 will be described in FIG. 15 and FIG. 16.

The electronic apparatus 100 may include a low-power timer 150. The at least one processor 120 may determine whether the first time is reached (or passed) based on the low-power timer 150. The at least one processor 120 may determine whether the first time is reached (or passed) by using the low-power timer 150 to which power is supplied.

The power-saving mode may be a mode in which only the low-power timer 150 and a power unit 160 are activated.

The communication standby mode may be a mode in which only the communication interface 130, the low-power timer 150, and the power unit 160 are activated.

The power unit 160 may include at least one from among a power controller 161, a rechargeable battery 162, a power adaptor 163, a harvesting Power Management Integrated Circuit (PMIC) 164, or a solar battery 165. The rechargeable battery 162 may be connected with at least one from among the power adaptor 163, the harvesting PMIC 164, or the solar battery 165.

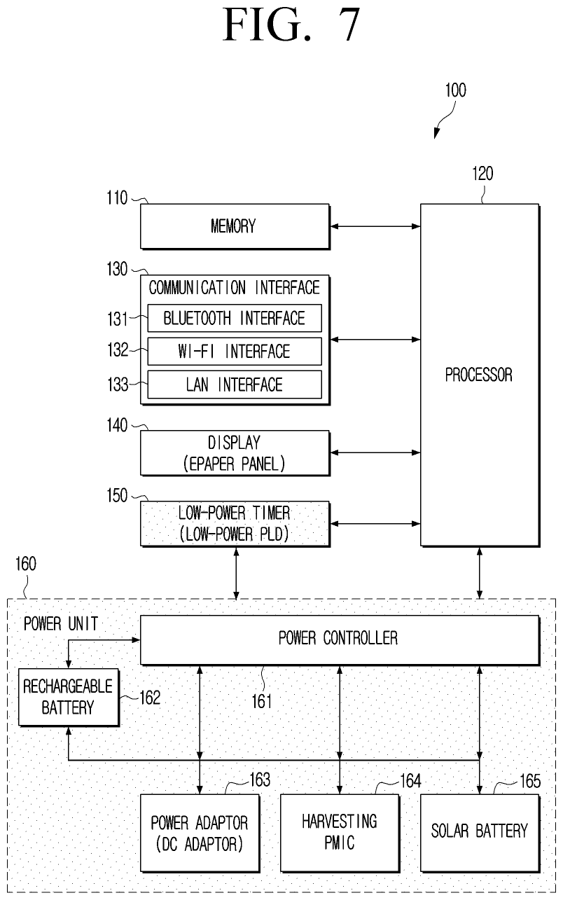

In the power-saving mode and the communication standby mode, power of the rechargeable battery 162 may be supplied to the low-power timer 150. According to an embodiment, the at least one processor 120 may control the power controller 161 to supply power of the rechargeable battery 162 to the low-power timer 150 in the power-saving mode and the communication standby mode. Descriptions associated therewith will be described in FIG. 7 to FIG. 9.

The electronic apparatus 100 may use the communication standby mode in which a communication function can be performed in addition to the power-saving mode in which power is saved. When the electronic apparatus 100 is set to always perform the communication function, power consumption may be high. When operating the electronic apparatus 100 in the normal mode in preparation for a control command to be received from the external device 200, power consumption may be high. The electronic apparatus 100 may effectively manage power by using the power-saving mode, the communication standby mode, and the normal mode.

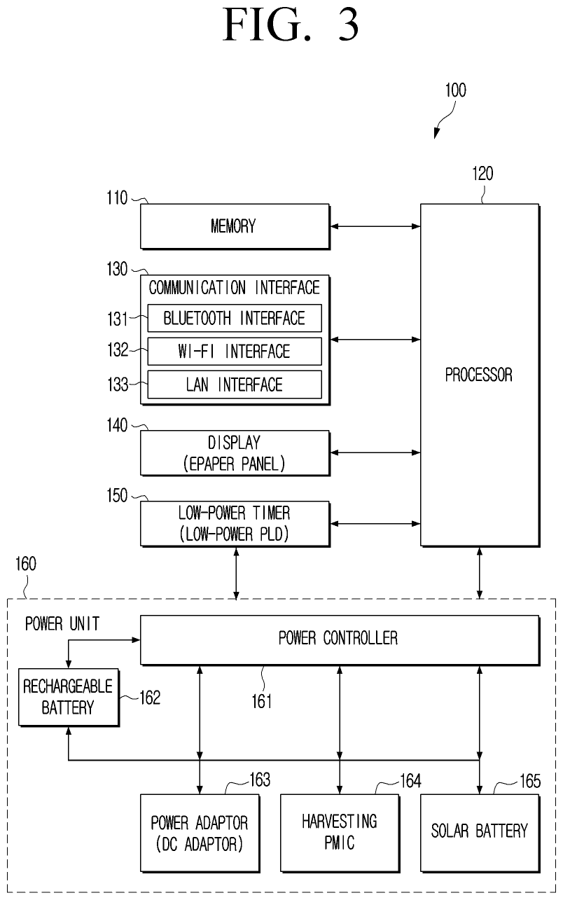

FIG. 3 is a block diagram illustrating a detailed configuration of the electronic apparatus 100 of FIG. 2 according to an embodiment.

Referring to FIG. 3, the electronic apparatus 100 may include at least one from among a memory 110, the communication interface 130, the display 140, the low-power timer 150, and the power unit 160.

The memory 110 may be implemented as an internal memory such as a read only memory (ROM) (e.g., an electrically erasable programmable read-only memory (EEPROM)) and a random access memory (RAM) included in the at least one processor 120, or implemented as a memory separate from the at least one processor 120. The memory 110 may be implemented in a form of a memory embedded in the electronic apparatus 100 according to data storage use, or implemented in a form of a memory attachable to or detachable from the electronic apparatus 100. For example, data for driving of the electronic apparatus 100 may be stored in the memory embedded in the electronic apparatus 100, and data for an expansion function of the electronic apparatus 100 may be stored in the memory attachable to or detachable from the electronic apparatus 100.

The memory embedded in the electronic apparatus 100 may be implemented as at least one from among a volatile memory (e.g., a dynamic RAM (DRAM), a static RAM (SRAM), or a synchronous dynamic RAM (SDRAM)), or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)) or in the case of the memory attachable to and detachable from the electronic apparatus 100, may be implemented in a form such as, for example, and without limitation, a memory card (e.g., a compact flash (CF), a secure digital (SD), a micro secure digital (micro-SD), a mini secure digital (mini-SD), an extreme digital (xD), or a multi-media card (MMC), for example), an external memory (e.g., a USB memory) connectable to a USB port, or the like.

The memory 110 may store at least one instruction. Based on the instructions stored in the memory 110, the at least one processor 120 may perform various operations.

The at least one processor 120 may be implemented as a digital signal processor (DSP) for processing digital signals, a microprocessor, or a time controller (TCON). The embodiment is not limited thereto, and may include one or more from among a central processing unit (CPU), a micro controller unit (MCU), a micro processing unit (MPU), a controller, an application processor (AP), a graphics-processing unit (GPU), a communication processor (CP), or Advanced Reduced instruction set computer (RISC) Machines (ARM) processor, or may be defined by a relevant term. The at least one processor 120 may be implemented as a System on Chip (SoC) or a large scale integration (LSI) in which a processing algorithm is embedded, and may be implemented in a form of a field programmable gate array (FPGA). The at least one processor 120 may perform various functions by executing computer executable instructions stored in the memory.

The communication interface 130 may be a configuration for performing communication with external devices of various types according to communication methods of various types. The communication interface 130 may include a wireless communication module or a wired communication module. Each communication module may be implemented in at least one hardware chip form.

The wireless communication module may be a module for communicating with external devices via wireless communication. For example, the wireless communication module may include at least one module from among a Wi-Fi interface, a Bluetooth interface, an infrared communication module, or other communication modules.

The Wi-Fi interface and the Bluetooth interface may perform communication in a Wi-Fi method and a Bluetooth method, respectively. When using the Wi-Fi interface or the Bluetooth interface, various connection information such as a service set identifier (SSID) and a session key may be first transmitted and received, and various information may be transmitted and received after communicatively connecting using the same.

The infrared communication module may perform communication according to an infrared communication (Infrared Data Association (IrDA)) technology of transmitting data wirelessly in short range by using infrared rays present between visible rays and millimeter waves.

The other communication modules may include at least one communication chip for performing communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like in addition to the above-described communication methods.

The wired communication module may be a module for communicating with external devices via wired communication. For example, the wired communication module may include at least one from among, a Local Area Network (LAN) interface, an Ethernet module, a pair cable, a coaxial cable, an optical fiber cable, or an ultra wide-band (UWB) module.

According to an embodiment, the communication interface 130 may use the same communication module (e.g., Wi-Fi interface) for communicating with external devices such as a remote control device and an external server.

According to an embodiment, the communication interface 130 may use different communication modules for communicating with external devices such as the remote control device and the external server. For example, the communication interface 130 may use at least one from among the Ethernet module or the Wi-Fi interface to communicate with the external server, and use the Bluetooth interface to communicate with external devices such as the remote control device. The above describes an example implementation. The communication interface 130 may use at least one communication module from among various communication modules when communicating with a plurality of external devices or the external server.

The communication interface 130 may include at least one from among the Bluetooth interface 131, the Wi-Fi interface 132, or a LAN interface 133.

The display 140 may include an e-Paper panel. The display 140 may include a module displaying an image using electronic ink. The display may be implemented as one from among the ElectroPhoretic Display, the Electrowetting Display, or the Interferometric Modulator Display.

The low-power timer 150 may include a low-power Programmable Logic Device (PLD). The low-power timer 150 may be a module which checks a pre-set time. The low-power timer 150 may check whether the pre-set time has passed. The low-power timer 150 may check whether the pre-set time has passed from a time-point. The electronic apparatus 100 may check the pre-set time by using the low-power timer 150. The electronic apparatus 100 may perform a function for every hour.

The power unit 160 may include at least one from among the power controller 161, the rechargeable battery 162, the power adaptor 163, the harvesting PMIC 164, and the solar battery 165.

The power controller 161 may be a module for controlling power supplied to the electronic apparatus 100. The power controller 161 may be connected with at least one from among the rechargeable battery 162, the power adaptor 163, the harvesting PMIC 164, and the solar battery 165.

The power controller 161 may be supplied with power from the rechargeable battery 162. The power controller 161 may provide power obtained from the rechargeable battery 162 to at least one hardware configuration included in the electronic apparatus 100.

The power controller 161 may be supplied with power from at least one from among the power adaptor 163, the harvesting PMIC 164, and the solar battery 165.

The power controller 161 may be connected with at least one from among the low-power timer 150 or the at least one processor 120.

The power controller 161 may provide the supplied power to the low-power timer 150 or the at least one processor 120.

The rechargeable battery 162 may store power by the power controller 161. The rechargeable battery 162 may be implemented as rechargeable batteries of various types. The rechargeable battery 162 may be connected to at least one from among the power adaptor 163, the harvesting PMIC 164, or the solar battery 165. The rechargeable battery 162 may be supplied with power from at least one from among the power adaptor 163, the harvesting PMIC 164, and the solar battery 165.

The power adaptor 163 may be connected to at least one of the power controller 161 or the rechargeable battery 162. The power adaptor 163 may include a module for transmitting power supplied externally to the electronic apparatus 100. The power adaptor 163 may include a direct current (DC) adaptor. The power adaptor 163 may convert alternating current power supplied externally to direct current power. The power adaptor 163 may supply the converted direct current power to the low-power timer 150 or the at least one processor 120 through the power controller 161.

The harvesting PMIC 164 may be connected to at least one of the power controller 161 or the rechargeable battery 162. The harvesting PMIC 164 may include a harvesting Power Management Integrated Circuit (PMIC). The harvesting PMIC 164 may include a module for generating power by an external energy source. For example, the harvesting PMIC 164 may include a module for generating power based on at least one from among light energy, heat energy, and vibration energy.

The solar battery 165 may be a module for generating electric energy by receiving sunlight. The solar battery 165 may include a module for generating electric energy by using a photoelectric effect.

FIG. 4 is a diagram illustrating an operation for changing a mode by using a physical button according to an embodiment.

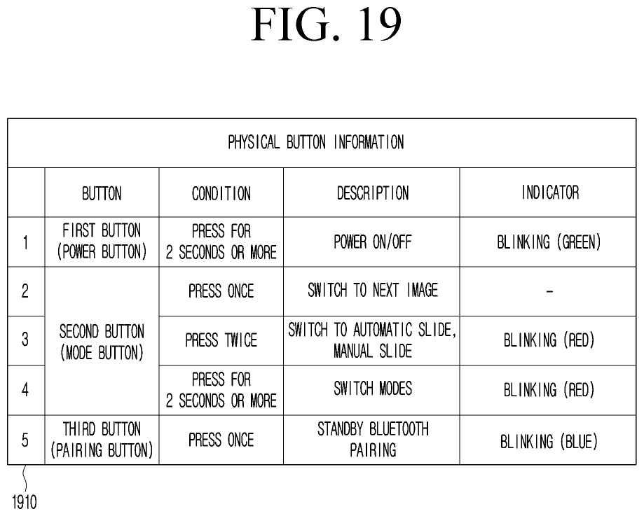

Referring to FIG. 4, the electronic apparatus 100 may operate in one mode from among the power-saving mode, the communication standby mode, or the normal mode. The electronic apparatus 100 may include an operating interface. The operating interface may include a physical button. The electronic apparatus 100 may receive a user input through the physical button. Additional description for the physical button will be described in FIG. 19.

When a user input is received through the physical button, the electronic apparatus 100 may change the mode. A changing order may be the normal mode, the power-saving mode, and the communication standby mode. The changing order of the modes may be changed according to setting by the user.

In an example, if a user input for selecting the physical button once is received while a current mode is in the normal mode, the electronic apparatus 100 may change the normal mode to the power-saving mode.

In an example, if the user input selecting the physical button once is received while the current mode is in the power-saving mode, the electronic apparatus 100 may change the power-saving mode to the communication standby mode.

In an example, if the user input selecting the physical button once is received while the current mode is in the communication standby mode, the electronic apparatus 100 may change the communication standby mode to the normal mode.

The normal model may indicate a mode in which all functions associated with the electronic apparatus 100 can be performed. The normal mode may indicate a state in which power can be supplied to all modes included in the electronic apparatus 100.

The power-saving mode may be a mode in which the low-power timer 150 and the power unit 160 are turned-on. The power-saving mode may be a mode in which power is supplied to the low-power timer 150 through the power unit 160. Power may not be supplied to other hardware configurations.

The communication standby mode may be a mode in which the communication interface 130, the low-power timer 150, and the power unit 160 are turned-on. In the communication standby mode, the electronic apparatus 100 may perform the communication function. In the power-saving mode, the electronic apparatus 100 may not perform the communication function. In the communication standby mode, the electronic apparatus 100 may not perform an operation for updating an image or changing the image.

In the communication standby mode, the electronic apparatus 100 may perform only a timer function of calculating the pre-set time and communication function.

In an example, in the communication standby mode, the electronic apparatus 100 may control at least one module of the Bluetooth interface 131 or the Wi-Fi interface 132 only in an on-state. In the communication standby mode, the electronic apparatus 100 may supply power to at least one module of the Bluetooth interface 131 or the Wi-Fi interface 132 only through the power unit 160.

According to an embodiment, the electronic apparatus 100 may include modules for the power-saving mode, the communication standby mode, and the normal mode, respectively. A module for the power-saving mode may be described as a first module or a power-saving mode module. A module for the communication standby mode may be described as a second module or a communication standby mode module. A module for the normal mode may be described as a third module or a normal mode module.

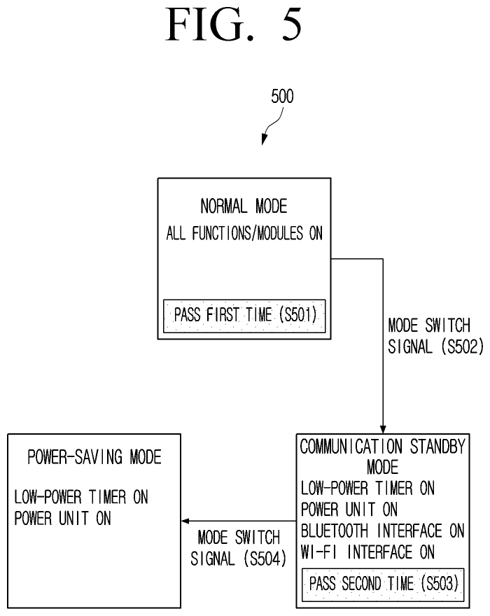

FIG. 5 is a diagram illustrating an operation in which a mode is automatically changed according to an embodiment.

Referring to FIG. 5, the electronic apparatus 100 may switch modes based on a pre-set event. The electronic apparatus 100 may automatically change modes when the pre-set time has passed. The pre-set time may include at least one of the first time or the second time.

The electronic apparatus 100 may identify an event passing the first time in the normal mode (S501). When the event passing the first time in the normal mode is identified, the electronic apparatus 100 may generate a mode switch signal (S502). The electronic apparatus 100 may change the normal mode to the communication standby mode based on the mode switch signal. The electronic apparatus 100 may operate in the communication standby mode.

The electronic apparatus 100 may identify an event of the second time passing from a time-point of operating in the communication standby mode (S503). When the event of the second time passing from the communication standby mode is identified, the electronic apparatus 100 may generate the mode switch signal (S504). The electronic apparatus 100 may change the communication standby mode to the power-saving mode based on the mode switch signal. The electronic apparatus 100 may operate in the power-saving mode.

In an example, the first time and the second time may be the same.

In an example, the first time and the second time may be different.

According to an embodiment, the electronic apparatus 100 may identify an event in which a user input is not received for a pre-set time. If the user input (e.g., input of the physical button) is not received for the first time or the second time described above, the electronic apparatus 100 may change modes by generating the mode switch signal.

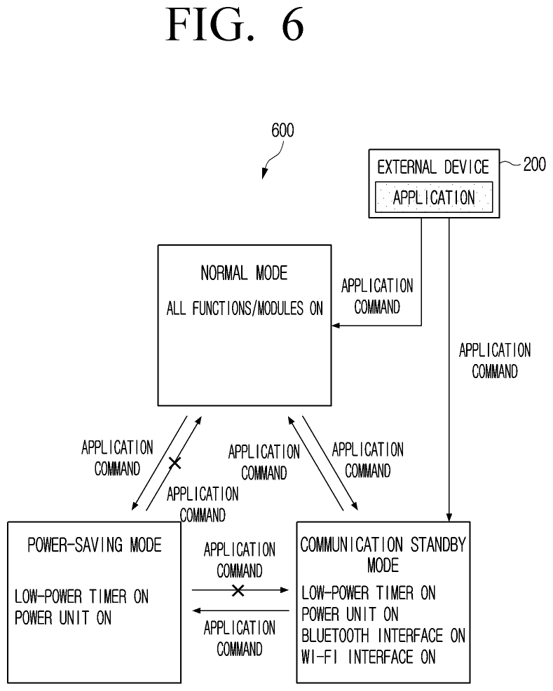

FIG. 6 is a diagram illustrating an operation for changing a mode through an application command according to an embodiment.

Referring to FIG. 6, the electronic apparatus 100 may communicatively connect with the external device 200. The electronic apparatus 100 may receive an application command from the external device 200. The external device 200 may store an application for controlling the electronic apparatus 100. The external device 200 may generate an application command based on a user input.

The application command may be a command for switching modes. The application command may include a control command generated from the application and a mode switching command generated from the application.

The electronic apparatus 100 may switch modes based on the application command received from the external device 200.

In the normal mode, the electronic apparatus 100 may receive the application command from the external device 200. The electronic apparatus 100 may change from the normal mode to the power saving mode or the communication standby mode based on the application command.

In the communication standby mode, the electronic apparatus 100 may receive the application command from the external device 200. The electronic apparatus 100 may change from the communication standby mode to the normal mode or the power-saving mode based on the application command.

The electronic apparatus 100 may not perform the mode switching command in the power-saving mode from among the plurality of modes. This is because power is supplied to only the low-power timer 150 in the power-saving mode. In the power-saving mode, the electronic apparatus 100 may not receive the application command from the external device. The electronic apparatus 100 may not change modes according to the application command in the power-saving mode.

FIG. 7 is a diagram illustrating the electronic apparatus 100 operating in a power-saving mode according to an embodiment.

Referring to FIG. 7, the electronic apparatus 100 may operate in the power-saving mode. The electronic apparatus 100 may activate the power unit 160 in the power-saving mode. The electronic apparatus 100 may supply power to the low-power timer 150 through the power unit 160.

The electronic apparatus 100 may determine whether a pre-set time is reached by using the low-power timer 150 in the power-saving mode. The pre-set time may be described as the pre-defined time.

In the power-saving mode, at least one from among the power controller 161, the rechargeable battery 162, the power adaptor 163, the harvesting PMIC 164, and the solar battery 165 may be activated.

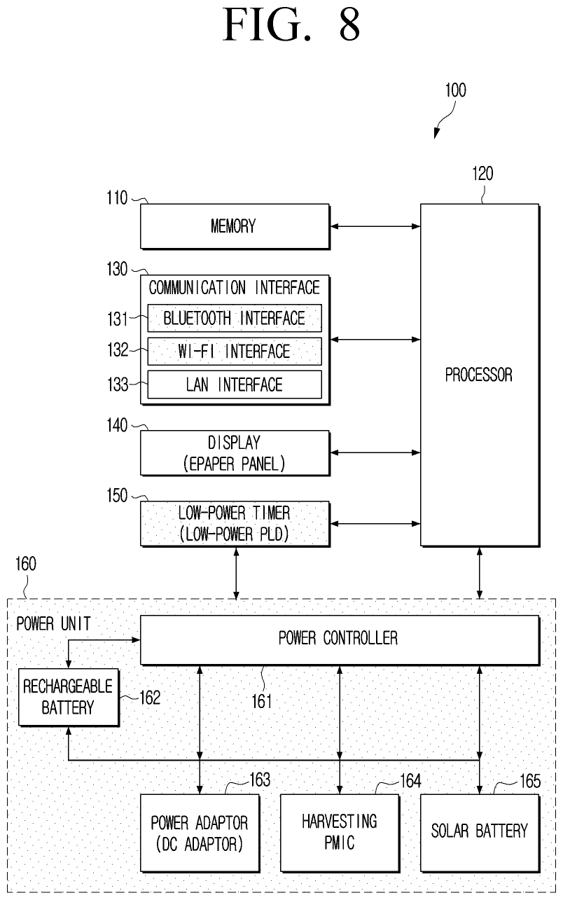

FIG. 8 is a diagram illustrating the electronic apparatus 100 operating in a communication standby mode according to an embodiment.

Referring to FIG. 8, the electronic apparatus 100 may operate in the communication standby mode. The electronic apparatus 100 may activate the power unit 160 in the communication standby mode. The electronic apparatus 100 may supply power to the low-power timer 150 and the communication interface 130 through the power unit 160.

The electronic apparatus 100 may determine whether the pre-set time is reached by using the low-power timer 150 in the communication standby mode.

The electronic apparatus 100 may receive information from the external device 200 using the communication interface 130 in the communication standby mode. The information received from the external device 200 may include various commands for controlling the electronic apparatus 100.

In an example, at least one from among the Bluetooth interface 131 or the Wi-Fi interface 132 from among the plurality of modules included in the communication interface 130 may be activated in the communication standby mode.

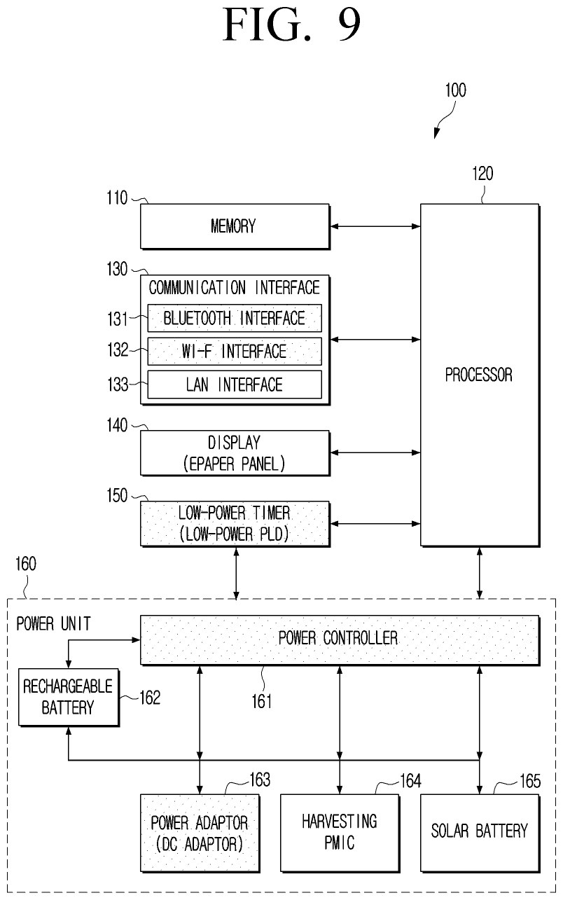

FIG. 9 is a diagram illustrating the electronic apparatus 100 operating in a communication standby mode according to an embodiment.

Referring to FIG. 9, the electronic apparatus 100 may operate in the communication standby mode. The electronic apparatus 100 may activate the power controller 161 and the power adaptor 163 from among the plurality of modules of the power unit 160 in the communication standby mode. The electronic apparatus 100 may operate in the communication standby mode only when external power is supplied through the power adaptor 163.

According to an embodiment, when external power is not supplied through the power adaptor 163, the electronic apparatus 100 may operate in the power-saving mode rather than operating in the communication standby mode.

According to an embodiment, when external power is not supplied through the power adaptor 163, the electronic apparatus 100 may operate in the communication standby mode using the rechargeable battery 162. If remaining power of the rechargeable battery 162 is less than or equal to a threshold value, the electronic apparatus 100 may operate in the power-saving mode rather than operating in the communication standby mode.

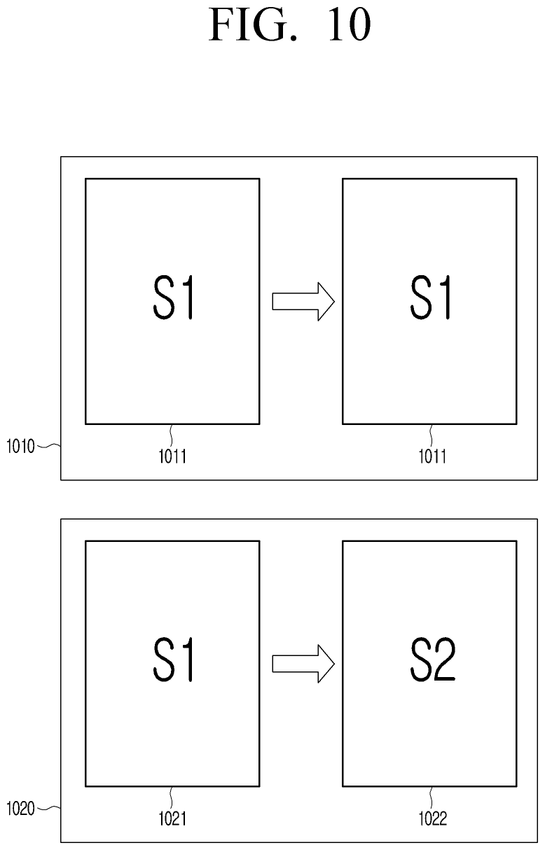

FIG. 10 is a diagram illustrating an image updating (or changing) operation according to an embodiment.

The electronic apparatus 100 may have a problem of residual image sticking due to remaining current. To solve this image sticking problem, the electronic apparatus 100 may update (or change) an image for every pre-set time.

Referring to embodiment 1010 in FIG. 10, the electronic apparatus 100 may perform an image updating operation. The image updating operation may mean displaying the same image again in a display panel. The electronic apparatus 100 may control the display panel to an on-state at a time-point when the image is updated.

Referring to embodiment 1020 in FIG. 10, the electronic apparatus 100 may perform an image changing operation. The image changing operation may mean displaying a second image 1022 different from a first image 1021 in the display panel. The electronic apparatus 100 may control the display panel to an on-state at a time-point when the image is changed.

When the image is updated or changed while the display panel is in the on-state, the image may be displayed regardless of the on-state or an off-state of the display panel after the image has been updated or changed.

FIG. 11 is a diagram illustrating an image updating (or changing) operation in a power-saving mode and a normal mode according to an embodiment.

Referring to FIG. 11, the electronic apparatus 100 may identify an event of reaching the pre-set time in the power-saving mode (S1101). The electronic apparatus 100 may identify whether the pre-set time is reached using the low-power timer 150.

When identifying that the pre-set time has been reached, the electronic apparatus 100 may generate a wake-up signal (S1102). The electronic apparatus 100 may operate in the normal mode based on the wake-up signal. The at least one processor 120 of the electronic apparatus 100 may be activated in the normal mode.

In the normal mode, the electronic apparatus 100 may perform the image updating (or image changing) operation (S1103). When the image updating (or image changing) operation is completed, the electronic apparatus 100 may generate a return signal (1104). The return signal may indicate a signal for changing from the normal mode to the power-saving mode. The electronic apparatus 100 may operate from the normal mode to the power-saving mode based on the return-signal.

FIG. 12 is a diagram illustrating an image updating (or changing) operation in a power-saving mode and a normal mode according to an embodiment. When the image updating (or image changing) operation is completed, the electronic apparatus 100 may generate a

Operations of FIG. 12 may correspond to operations of FIG. 11. Accordingly, for additional implementation details, reference may be made to the descriptions of FIG. 11.

The electronic apparatus 100 may display the first image in the normal mode (S1005). The electronic apparatus 100 may change from the normal mode to the power-saving mode (S1010).

The electronic apparatus 100 may identify whether the pre-set time is reached using the low-power timer 150 (S1015). When reaching the pre-set time (S1015-Y), the electronic apparatus 100 may change the power-saving mode to the normal mode (S1020).

When changed to the normal mode, the electronic apparatus 100 may update the first image (S1025). When the first image is updated, the electronic apparatus 100 may change the normal mode to the power-saving mode. The electronic apparatus 100 may repeatedly perform steps S1010, S1015, S1020, and S1025.

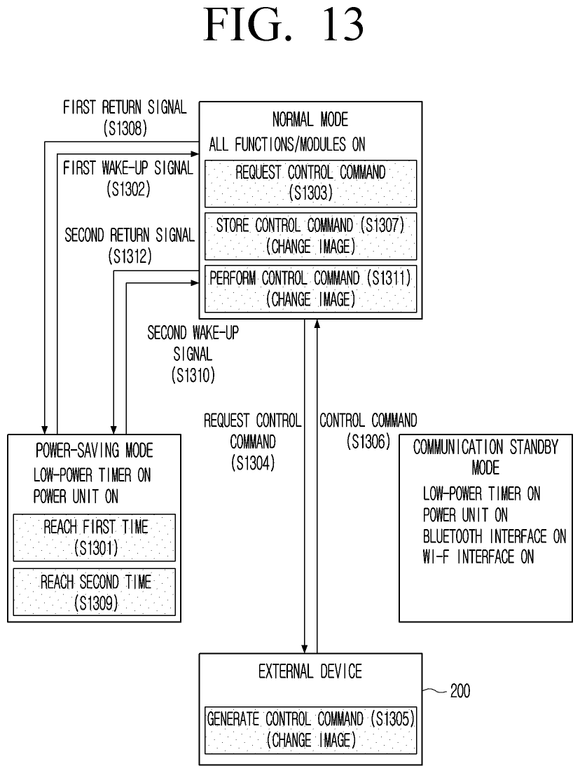

FIG. 13 is a diagram illustrating an operation for performing a control command received from the external device 200 according to an embodiment.

Referring to FIG. 13, it may be assumed that the electronic apparatus 100 is displaying the first image in the power-saving mode. In the power-saving mode, the electronic apparatus 100 may identify whether a pre-set first time is reached (S1301). When identifying that the first time is reached, the electronic apparatus 100 may generate a first wake-up signal (S1302). The first wake-up signal may include a signal for converting to the normal mode.

The electronic apparatus 100 may change the power-saving mode to the normal mode based on the first wake-up signal. The electronic apparatus 100 may request, to the external device 200, a control command in the normal mode (S1303).

The external device 200 may receive the request for the control command from the electronic apparatus 100. After the request for the control command is received, the external device 200 may generate a control command associated with the electronic apparatus 100 (S1305). In an example, the control command may be a command for converting an image. The external device 200 may transmit the control command to the electronic apparatus 100 (S1306).

The control command may be a command performed after the pre-set time from the received time-point. The electronic apparatus 100 may not immediately perform (or execute) the control command. The electronic apparatus 100 may store the control command, and perform the control command based on a pre-set event thereafter.

For example, the pre-set event may include an event of schedule information, which is to be performed at a pre-set time (or date), being included in the control command.

The electronic apparatus 100 may receive the control command from the external device 200. The electronic apparatus 100 may store the control command (S1307). After the control command is stored, the electronic apparatus 100 may generate a first return signal (S1308). The first return signal may include a signal for converting to the power-saving mode.

The electronic apparatus 100 may change from the normal mode to the power-saving mode based on the first return signal. After being changed to the power-saving mode based on the first return signal, the electronic apparatus 100 may identify an event of reaching the second time (S1309). When reaching the second time, the electronic apparatus 100 may generate a second wake-up signal (S1310). The second wake-up signal may include a signal for changing to the normal mode.

The electronic apparatus 100 may change from the power-saving mode to the normal mode based on the second wake-up signal. In the normal mode, the electronic apparatus 100 may perform the stored control command (S1311). In an example, the electronic apparatus 100 may change the first image to the second image based on the control command. When performing the control command, the electronic apparatus 100 may generate a second return signal (S1312). The second return signal may include a signal for changing from the normal mode to the power-saving mode.

The electronic apparatus 100 may change from the normal mode to the power-saving mode based on the second return signal. In the power-saving mode, the second image may be displayed.

According to an embodiment, the first time and the second time may be different. In an example, the first time may be shorter than the second time.

According to an embodiment, the first time and the second time may be the same.

FIG. 14 is a diagram illustrating an image updating (or changing) operation in a communication standby mode and a normal mode according to an embodiment.

Referring to FIG. 14, the electronic apparatus 100 may display the first image in the communication standby mode. In the communication standby mode, the electronic apparatus 100 may identify an event of reaching the pre-set time (S1401). When reaching the pre-set time, the electronic apparatus 100 may generate a wake-up signal (S1402). The wake-up signal may include signal for changing to the normal mode.

The electronic apparatus 100 may change from the communication standby mode to the normal mode based on the wake-up signal. After being changed to the normal mode, the electronic apparatus 100 may perform image updating (or image changing) (S1403). After the image updating (or image changing) is performed, the electronic apparatus 100 may generate a return signal (S1404). The return signal may include a signal for changing to the communication standby mode.

The electronic apparatus 100 may change from the normal mode to the communication standby mode based on the return signal. The electronic apparatus 100 may operate in the communication standby mode while the updated first image (or changed second image) is displayed.

FIG. 15 is a diagram illustrating an operation for performing a control command received from the external device 200 according to an embodiment.

Referring to FIG. 15, it may be assumed that the first image is displayed in the communication standby mode. The external device 200 may generate a control command (S1501). The external device 200 may transmit the control command to the electronic apparatus 100 (S1502). In an example, the control command may be a control command for the image changing. The control command may be a command for changing the first image to the second image.

The electronic apparatus 100 may receive the control command from the external device 200 in a state of the communication standby mode (S1503). The electronic apparatus 100 may generate a wake-up signal (S1504). The wake-up signal may include a signal for changing to the normal mode. The electronic apparatus 100 may change the communication standby mode to the normal mode based on the wake-up signal.

In the normal mode, the electronic apparatus 100 may perform the control command received from the external device 200 (S1505). In an example, the electronic apparatus 100 may change the first image to the second image based on the control command received from the external device 200. The electronic apparatus 100 may display the second image.

When the control command is performed, the electronic apparatus 100 may generate a return signal (S1506). The return signal may include a signal for changing to the communication standby mode. The electronic apparatus 100 may change from the normal mode to the communication standby mode based on the return signal. In an example, the changed second image may be displayed in the communication standby mode.

FIG. 16 is a diagram illustrating an operation for performing a control command received from the external device 200 according to an embodiment.

Operations of FIG. 16 may correspond to operations of FIG. 15. Accordingly, for additional implementation details, reference may be made to the descriptions of FIG. 15.

In the normal mode, the electronic apparatus 100 may display the first image (S1605). After displaying the first image, the electronic apparatus 100 may change to the communication standby mode (S1610).

As the electronic apparatus 100 operates in the communication standby mode, information may be received from the external device 200. The external device 200 may receive a user input for image changing (S1615). The external device 200 may generate a control command for image changing (S1620). The external device 200 may transmit the control command for image changing to the electronic apparatus 100 (S1625).

In the communication standby mode, the electronic apparatus 100 may receive the control command from the external device 200. The electronic apparatus 100 may store the control command received from the external device 200 (S1630).

The electronic apparatus 100 may identify whether the first time is reached (S1635). When reaching the first time (S1635-Y), the electronic apparatus 100 may change to the normal mode (S1640). In the normal mode, the electronic apparatus 100 may change the first image to the second image based on the control command stored at step S1630 (S1645).

According to an embodiment, the second image may be a pre-stored image in the electronic apparatus 100.

According to an embodiment, the second image may be an image received from the external device 200.

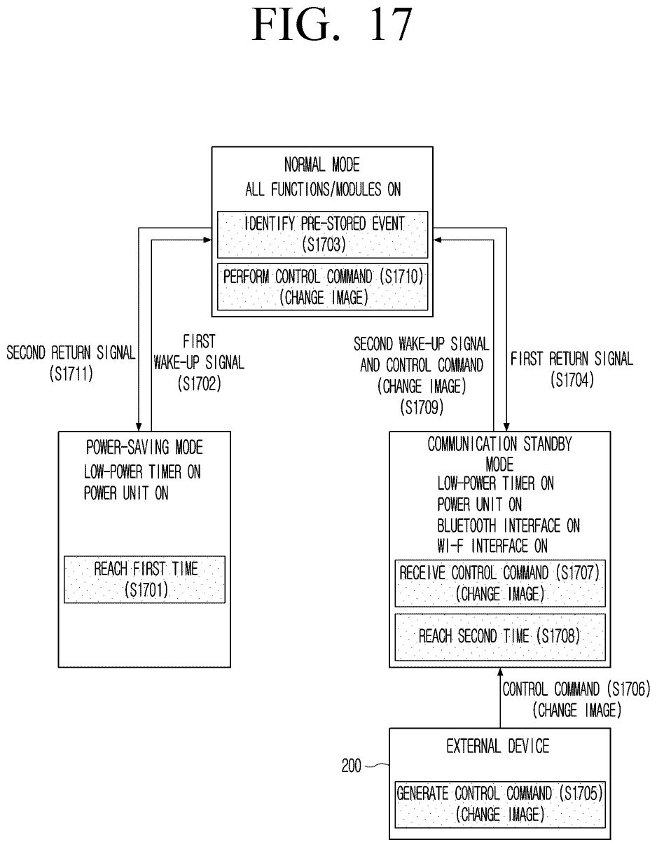

FIG. 17 is a diagram illustrating an operation for performing a control command in a power-saving mode, a communication standby mode, and a normal mode according to an embodiment.

Referring to FIG. 17, in the power-saving mode, the first image may be displayed. The electronic apparatus 100 may identify an event of reaching the pre-set time (S1701). When identifying the event of reaching the pre-set time, the electronic apparatus 100 may generate a first wake-up signal (S1702). The first wake-up signal may include a signal for changing to the normal mode.

The electronic apparatus 100 may change from the power-saving mode to the normal mode based on the first wake-up signal. In the normal mode, the electronic apparatus 100 may identify a pre-set event (S1703). The pre-set event may include an event for changing to the communication standby mode.

When the pre-set event is identified in the normal mode, the electronic apparatus 100 may generate a first return signal (S1704). The first return signal may include a signal for changing to the communication standby mode. The electronic apparatus 100 may change the normal mode to the communication standby mode based on the first return signal.

The external device 200 may generate a control command associated with the electronic apparatus 100 (S1705). In an example, the control command may include a command for image changing. The external device 200 may transmit the control command to the electronic apparatus 100 (S1706).

In the communication standby mode, the electronic apparatus 100 may receive the control command from the external device 200 (S1707). The electronic apparatus 100 may identify an event of reaching the second time (S1708). When reaching the second time, the electronic apparatus 100 may generate a second wake-up signal (S1709). The second wake-up signal may be a signal for changing to the normal mode.

The electronic apparatus 100 may change from the communication standby mode to the normal mode based on the second wake-up signal. In the normal mode, the electronic apparatus 100 may perform the control command (S1710). When the control command is performed, the electronic apparatus 100 may generate a second return signal (S1711). In an example, the electronic apparatus 100 may change the first image to the second image. The electronic apparatus 100 may display the second image. The second return signal may include a signal for changing to the power-saving mode.

The electronic apparatus 100 may change from the normal mode to the power-saving mode based on the second return signal. In an example, the second image may be displayed in the power-saving mode.

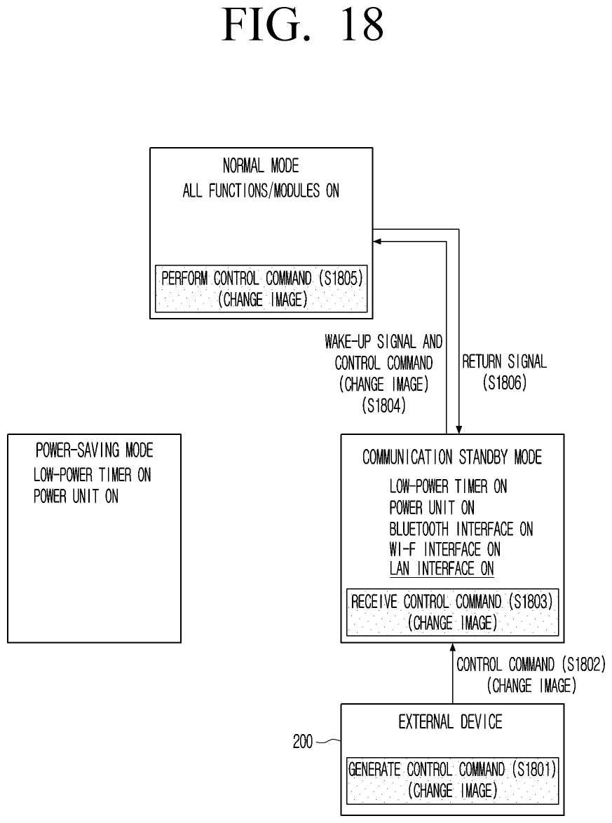

FIG. 18 is a diagram illustrating an operation for controlling a LAN interface according to an embodiment.

Steps S1801, S1802, S1803, S1804, S1805, and S1806 may correspond to steps S1501, S1502, S1503, S1504, S1505, and S1506 in FIG. 15. Accordingly, for additional implementation details, reference may be made to the descriptions of FIG. 15.

In FIG. 15, an embodiment of at least one module of the Bluetooth interface 131 or the Wi-Fi interface 132 being activated may be described.

In FIG. 18, an embodiment of the LAN interface 133 being activated may be described.

The electronic apparatus 100 may activate the LAN interface 133 in the communication standby mode. The electronic apparatus 100 may activate at least one from among the Bluetooth interface 131, the Wi-Fi interface 132, or the LAN interface 133. The electronic apparatus 100 may perform communication with the external device 200 through the LAN interface 133.

The electronic apparatus 100 may receive the control command from the external device 200 using the external device 200 and the LAN interface 133.

FIG. 19 is a diagram illustrating information associated with a physical button according to an embodiment.

Referring to FIG. 19, the electronic apparatus 100 may store physical button information 1910. The physical button information 1910 may include an operation performed by the electronic apparatus 100 based on a user input with respect to the physical button.

The electronic apparatus 100 may perform the user input through the operating interface including the physical button. According to an embodiment, the physical button may be one.

According to an embodiment, the physical button may be in plurality. The physical button may include at least one from among a first button (a power button), a second button (a mode button, a mode changing button), and a third button (a pairing button).

When a user input of pressing the first button for a pre-set time (2 seconds) or more is received, the electronic apparatus 100 may either turn-on power or turn-off power.

When the user input of pressing the first button for the pre-set time (2 seconds) or more is received while the power of the electronic apparatus 100 is in the off-state, the electronic apparatus 100 may turn-on power.

When the user input of pressing the first button for the pre-set time (2 seconds) or more is received while the power of the electronic apparatus 100 is in the on-state, the electronic apparatus 100 may turn-off power.

When power is changed (turned-on/turned-off), the electronic apparatus 100 may have light in a pre-set color (e.g., green) blinking. The electronic apparatus 100 may include a light outputting unit (e.g., LED). The electronic apparatus 100 may have light in the pre-set color (e.g., green) blinking by a threshold number of times through the light outputting unit.

When a user input of pressing the second button once is received, the electronic apparatus 100 may perform the image changing operation.

When a user input of pressing the second button twice is received, the electronic apparatus 100 may change a slide method. The slide method may be manual or automatic.

When the user input of pressing the second button twice is received while the slide method is in a manual state, the electronic apparatus 100 may change the slide method to automatic.

When the user input of pressing the second button twice is received while the slide method is in an automatic state, the electronic apparatus 100 may change the slide method to manual.

When the slide method is changed (manual/automatic), the electronic apparatus 100 may have light in a pre-set color (e.g., red) blinking. The electronic apparatus 100 may have light in the pre-set color (e.g., red) blinking by a threshold number of times through the light outputting unit.

When the user input of pressing the second button for a threshold time (2 seconds) or more is received, the electronic apparatus 100 may change modes. The mode may include at least one from among the power-saving mode, the communication standby mode, and the normal mode.

When the mode is changed, the electronic apparatus 100 may have light in the pre-set color (e.g., red) blinking by a threshold number of times for the threshold time.

When a user input of pressing the third button once is received, the electronic apparatus 100 may be in standby for Bluetooth pairing. The electronic apparatus 100 may perform an operation associated with the Bluetooth pairing to connect with the external device 200. The electronic apparatus 100 may maintain a pairing standby state.

While standing-by for the Bluetooth pairing, the electronic apparatus 100 may have light in a pre-set color (e.g., blue) blinking.

Colors of light, number of blinking times, blinking time, and the like may be changed according to a user setting.

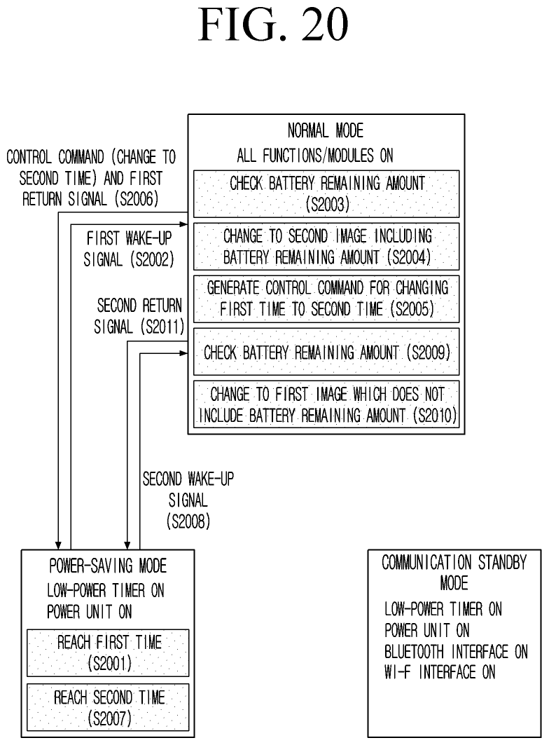

FIG. 20 is a diagram illustrating an operation for displaying a battery remaining amount according to an embodiment.

Referring to FIG. 20, the first image may be displayed in the power-saving mode. The electronic apparatus 100 may identify an event of reaching the first time (S2001). When reaching the first time, the electronic apparatus 100 may generate a first wake-up signal (S2002). The first wake-up signal may include a signal for changing to the normal mode.

The electronic apparatus 100 may change from the power-saving mode to the normal mode based on the first wake-up signal. In the normal mode, the electronic apparatus 100 may check the battery remaining amount (S2003).

If the battery remaining amount is less than a threshold value, the electronic apparatus 100 may display the second image including the battery remaining amount (S2004). The electronic apparatus 100 may change the first image to the second image.

After being changed to the second image, the electronic apparatus 100 may generate a control command for changing the first time associated with a function of the low-power timer 150 to the second time in the power-saving mode (S2005). The electronic apparatus 100 may generate a first return signal (S2006). The first return signal may include a signal for changing to the power-saving mode.

The electronic apparatus 100 may change from the normal mode to the power-saving mode based on the first return signal. The electronic apparatus 100 may transmit the control command to the low-power timer 150. The low-power timer 150 may change the first time to the second time based on the received control command. In the power-saving mode, the low-power timer 150 may determine whether the second time is reached. The second time may be shorter than the first time. This is because time that the second image indicating the battery remaining amount is displayed has to be reduced. The second image may be displayed in the power-saving mode.

In the power-saving mode, the electronic apparatus 100 may identify an event of reaching the second time (S2007). When reaching the second time, the electronic apparatus 100 may generate a second wake-up signal (S2008). The second wake-up signal may include a signal for changing to the normal mode.

The electronic apparatus 100 may change the power-saving mode to the normal mode based on the second wake-up signal. In the normal mode, the electronic apparatus 100 may check the battery remaining amount (S2009).

When the battery remaining amount is greater than or equal to the threshold value, the electronic apparatus 100 may change to the first image which does not include the battery remaining amount (S2010). The electronic apparatus 100 may change the second image to the first image. After changing to the first image, the electronic apparatus 100 may generate a second return signal (S2011).

The electronic apparatus 100 may change from the normal mode to the power-saving mode based on the second return signal. The first image may be displayed in the power-saving mode.

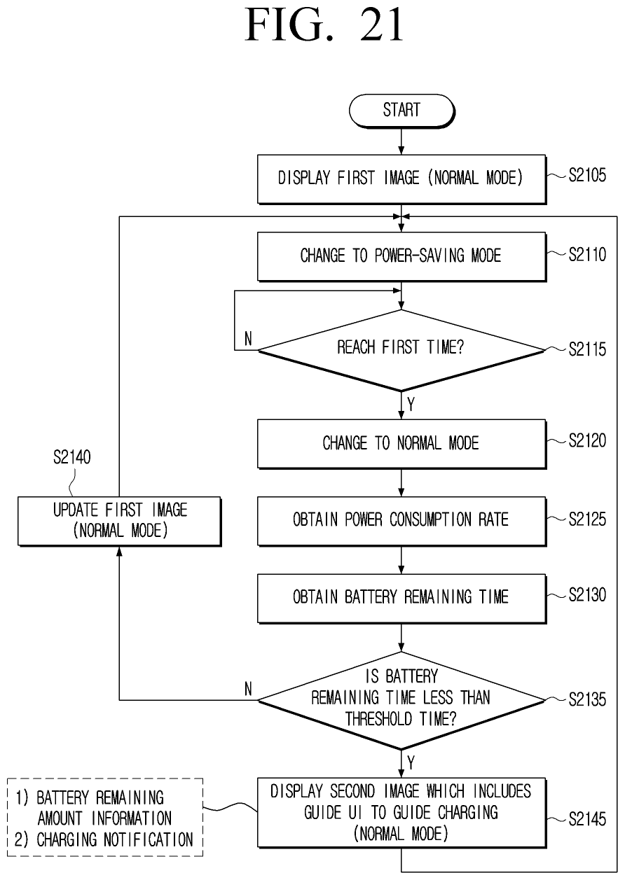

FIG. 21 is a diagram illustrating an operation for displaying an image including a charging guide UI according to an embodiment.

Operations of FIG. 21 may correspond to operations of FIG. 20. Accordingly, for additional implementation details, reference may be made to the descriptions of FIG. 20.

The electronic apparatus 100 may display the first image in the normal mode (S2105). The electronic apparatus 100 may change to the power-saving mode (S2110). The electronic apparatus 100 may identify whether the first time is reached (S2115).

When reaching the first time (S2115-Y), the electronic apparatus 100 may change to the normal mode (S2120). The electronic apparatus 100 may obtain a power consumption rate (S2125). The electronic apparatus 100 may obtain a battery remaining time (or battery remaining amount) based on the power consumption rate (S2130).

The electronic apparatus 100 may identify whether the battery remaining time is less than a threshold time (S2135).

If the battery remaining time is greater than or equal to the threshold time (S2135-N), the electronic apparatus 100 may update the first image in the normal mode. After having updated the first image, the electronic apparatus 100 may change to the power-saving mode (S2110). The electronic apparatus 100 may repeatedly perform steps S2110 to S2135.

If the battery remaining time is less than the threshold time (S2135-Y), the electronic apparatus 100 may display the second image which includes a guide UI to guide charging in the normal mode (S2145). After displaying the second image, the electronic apparatus 100 may repeatedly perform steps S2110 to S2135.

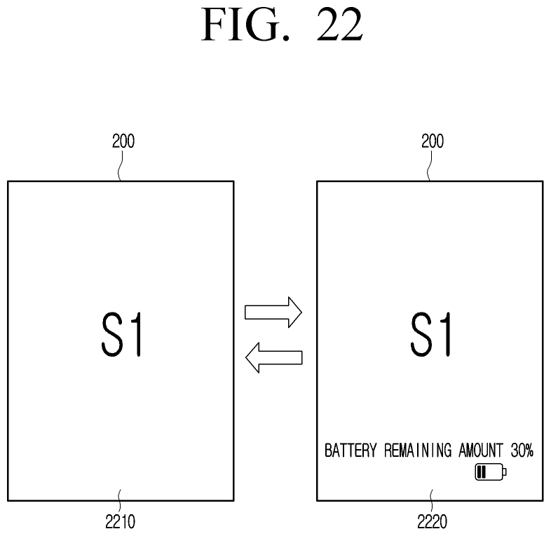

The guide UI may include at least one from among battery remaining amount, battery remaining time, and charging notification. Descriptions associated therewith will be described in FIG. 22 to FIG. 24.

FIG. 22 is a diagram illustrating an operation for displaying an image including a charging guide UI according to an embodiment.

Referring to FIG. 22, the electronic apparatus 100 may display a first image 2210. The electronic apparatus 100 may check the battery remaining amount while displaying the first image 2210. If the battery remaining amount is less than a threshold value, the electronic apparatus 100 may provide the user with information on the battery remaining amount. The electronic apparatus 100 may display a second image 2220 which includes a UI associated with the battery remaining amount.

An operation for checking the battery remaining amount may be performed in the normal mode. An operation for changing from the first image 2210 to the second image 2220 may be performed in the normal mode.

The battery remaining amount may be described as the battery remaining time.

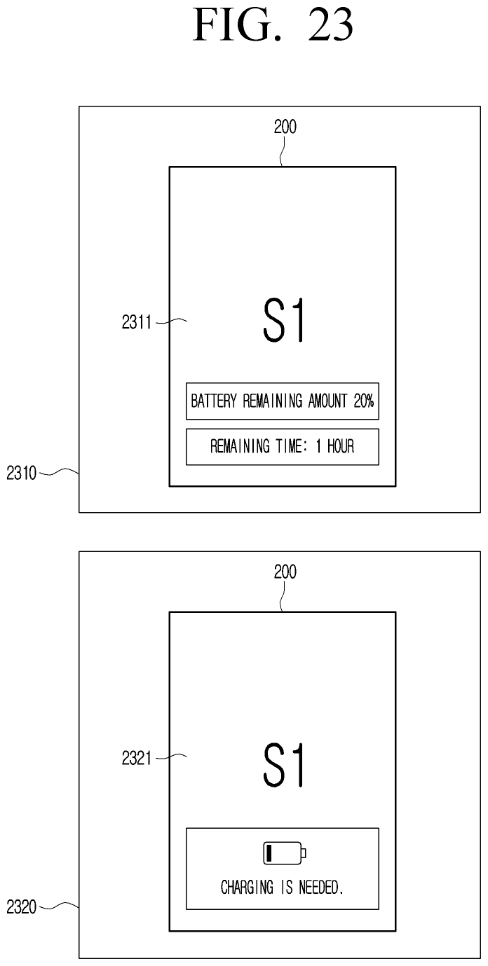

FIG. 23 is a diagram illustrating an operation for displaying an image including a charging guide UI according to an embodiment.

Referring to embodiment 2310 in FIG. 23, the electronic apparatus 100 may display a second image 2311 which includes a guide UI to guide charging. The guide UI may include at least one from among the battery remaining amount and the battery remaining time.

Referring to embodiment 2320 in FIG. 23, the electronic apparatus 100 may display a second image 2321 which includes a guide UI to guide charging. The guide UI may include information indicating that charging is necessary. The guide UI may include at least one of an image or text.

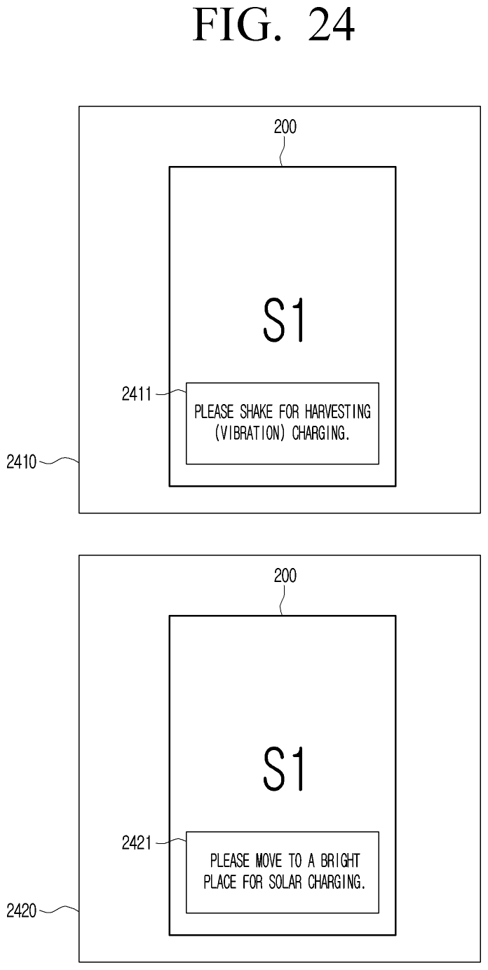

FIG. 24 is a diagram illustrating an operation for displaying an image including a charging guide UI according to an embodiment.

Referring to embodiment 2410 in FIG. 24, the electronic apparatus 100 may display a second image 2411 which includes a guide UI to guide charging. The guide UI may include information for a harvesting charge method.

Referring to embodiment 2420 in FIG. 24, the electronic apparatus 100 may display a second image 2421 which includes a guide UI to guide charging. The guide UI may include information for a solar charging method.

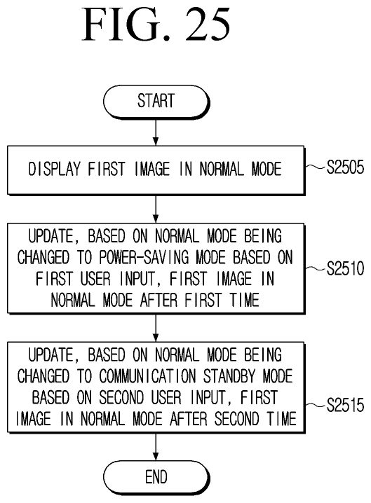

FIG. 25 is a diagram illustrating a controlling method of an electronic apparatus according to an embodiment.

Referring to FIG. 25, a controlling method of the electronic apparatus including the display, the communication interface, and the power unit may include displaying the first image in the normal mode (S2505), updating, based on the normal mode being changed to the power-saving mode based on the first user input, the first image in the normal mode after the first time (S2510), and updating, based on the normal mode being changed to the communication standby mode based on the second user input, the first image in the normal mode after the second time (S2515), and the communication interface may be deactivated in the power-saving mode, and activated in the communication standby mode.

The controlling method may include changing, based on the first user input being received, from the normal mode to the power-saving mode, changing, based on the event of reaching the first time in the power-saving mode being identified, the power-saving mode to the normal mode, updating the first image in the normal mode, and changing from the normal mode to the power-saving mode.

The control method may include changing, based on the second user input being received, from the normal mode to the communication standby mode, changing, based on the event of reaching the second time in the communication standby mode being identified, the communication standby mode to the normal mode, updating the first image in the normal mode, and changing from the normal mode to the communication standby mode.

The display may include the e-Paper display.

The display may include the electronic ink including the charged particles, and the updating the first image may include initializing the arrangement of the charged particles, and updating the first image by realigning the arrangement of the charged particles based on the first image.

The communication interface may include at least one from among the Bluetooth interface or the Wi-Fi interface, and the communication standby mode may be a mode which activates at least one from among the Bluetooth interface or the Wi-Fi interface.

The controlling method may include storing, based on the control command for image changing being received from the external device while operating in the communication standby mode, the control command, changing, based on the event of reaching the second time in the communication standby mode being identified, the communication standby mode to the normal mode, changing the first image to the second image based on the control command in the normal mode, and changing from the normal mode to the power-saving mode or the communication standby mode.

The electronic apparatus may include the low-power timer, and the controlling method may include determining whether the first time and the second time are reached based on the low-power timer.

The power unit may include at least one from among the power controller, the rechargeable battery, the power adaptor, the harvesting PMIC, or the solar battery, and the rechargeable battery may be connected with at least one from among the power adaptor, the harvesting PMIC, or the solar battery.

The controlling method may include supplying power of the rechargeable battery to the low-power timer through the power controller in the power-saving mode and the communication standby mode.

Methods according to the various embodiments of the disclosure described above may be implemented in an application form installable in the electronic apparatuses of the related art.

The methods according to the various embodiments of the disclosure described above may be implemented with only a software upgrade, or a hardware upgrade for the electronic apparatus of the related art.

The various embodiments of the disclosure described above may be performed through an embedded server provided in the electronic apparatus, or an external server of at least one from among the electronic apparatuses and the display apparatuses.

According to an embodiment of the disclosure, the various embodiments described above may be implemented with software including instructions stored in a machine-readable storage media (e.g., a computer). The machine may call an instruction stored in the storage medium, and as a device operable according to the called instruction, may include an electronic apparatus according to the above-mentioned embodiments. Based on a command being executed by the processor, the processor may directly or using other elements under the control of the processor perform a function relevant to the command. The command may include a code generated by a compiler or executed by an interpreter. The machine-readable storage media may be provided in a form of a non-transitory storage medium. Herein, ‘non-transitory’ means that a storage medium is tangible and does not include a signal, and the term does not differentiate data being semi-permanently stored or being temporarily stored in the storage medium.

According to an embodiment of the disclosure, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store. In the case of online distribution, at least a portion of the computer program product may be stored at least temporarily in the storage medium such as a server of a manufacturer, a server of an application store, or a memory of a relay server, or temporarily generated.

Each of the elements (e.g., a module or a program) according to various embodiments described above may be formed as a single entity or a plurality of entities, and other sub-elements may be further included in the various embodiments. A portion of the elements (e.g., modules or programs) may be integrated into one entity to perform the same or similar functions performed by each of the relevant elements prior to integration. Operations performed by a module, a program, or another element, in accordance with various embodiments, may be executed sequentially, in a parallel, repetitively, or in a heuristic manner, or at least a portion of the operations may be executed in a different order, or a different operation may be added.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus, comprising:
memory storing one or more instructions;
a communication interface;
a display; and
at least one processor comprising processing circuitry,
wherein the one or more instructions, when executed by the at least one processor individually or collectively, cause the electronic apparatus to:
control the display to display a first image in a first mode;
control, based on the first mode being changed to a second mode based on a first user input, the display to update the first image in the first mode after a first time; and
control, based on the first mode being changed to a third mode based on a second user input, the display to update the first image in the first mode after a second time, and
wherein the communication interface is deactivated in the second mode, and activated in the third mode.

2. The electronic apparatus of claim 1, wherein the first mode is a normal mode, the second mode is a power saving mode, and the third mode is a communication standby mode.

3. The electronic apparatus of claim 2, wherein the one or more instructions, when executed by the at least one processor individually or collectively, cause the electronic apparatus to:
change, based on the first user input being received, from the first mode to the second mode;
change, based on the first time being reached in the second mode being identified, the second mode to the first mode;
control the display to update the first image in the first mode; and
change from the first mode to the second mode.

4. The electronic apparatus of claim 2, wherein the one or more instructions, when executed by the at least one processor individually or collectively, cause the electronic apparatus to:
change, based on the second user input being received, from the first mode to the third mode;
change, based on the second time being reached in the third mode, the third mode to the first mode;
control the display to update the first image in the first mode; and
change from the first mode to the third mode.

5. The electronic apparatus of claim 2, wherein the display comprises an e-Paper display.

6. The electronic apparatus of claim 5, wherein the e-Paper display comprises electronic ink comprising charged particles, and
wherein the one or more instructions, when executed by the at least one processor individually or collectively, cause the electronic apparatus to: initialize an arrangement of the charged particles, and control the e-Paper display to update the first image by realigning the arrangement of the charged particles based on the first image.

7. The electronic apparatus of claim 2, wherein the communication interface comprises at least one from among a Bluetooth interface or a Wi-Fi interface, and
wherein the third mode activates at least one from among the Bluetooth interface or the Wi-Fi interface.

8. The electronic apparatus of claim 2, wherein the one or more instructions, when executed by the at least one processor individually or collectively, cause the electronic apparatus to:
store, based on a control command for image changing being received from an external device while operating in the third mode, the control command;
change, based on the second time being reached in the third mode, the third mode to the first mode;
control the display to change the first image to a second image based on the control command in the first mode; and
change from the first mode to the second mode or the third mode.

9. The electronic apparatus of claim 2, wherein the electronic apparatus further comprises a low-power timer, and
wherein the one or more instructions, when executed by the at least one processor individually or collectively, cause the electronic apparatus to determine whether the first time and the second time are reached using the low-power timer.

10. The electronic apparatus of claim 9, wherein the electronic apparatus further comprises a power unit comprising at least one from among a power controller, a rechargeable battery, a power adaptor, a harvesting Power Management Integrated Circuit (PMIC), or a solar battery,
wherein the rechargeable battery is connected with at least one from among the power adaptor, the harvesting PMIC, or the solar battery, and
wherein the one or more instructions, when executed by the at least one processor individually or collectively, cause the electronic apparatus to supply power of the rechargeable battery to the low-power timer through the power controller in the second mode and the third mode.

11. A controlling method of an electronic apparatus including a display and a communication interface, the controlling method comprising:
displaying a first image in a first mode;
updating, based on the first mode being changed to a second mode based on a first user input, the first image in the first mode after a first time; and
updating, based on the first mode being changed to a third mode based on a second user input, the first image in the first mode after a second time,
wherein the communication interface is deactivated in the second mode, and activated in the third mode.

12. The controlling method of claim 11, wherein the first mode is a normal mode, the second mode is a power saving mode, and the third mode is a communication standby mode.

13. The controlling method of claim 12, further comprising:
changing, based on the first user input being received, from the first mode to the second mode;
changing, based on the first time being reached in the second mode, the second mode to the first mode;
updating the first image in the first mode; and
changing from the first mode to the second mode.

14. The controlling method of claim 12, further comprising:
changing, based on the second user input being received, from the first mode to the third mode;
changing, based on the second time being reached in the third mode, the third mode to the first mode;
updating the first image in the first mode; and
changing from the first mode to the third mode.

15. The controlling method of claim 12, wherein the display comprises an e-Paper display.

16. The method of claim 14, wherein
the e-Paper display comprises electronic ink comprising charged particles, and
wherein the updating the first image comprises initializing an arrangement of the charged particles, and updating the first image by realigning the arrangement of the charged particles based on the first image.

17. The controlling method of claim 12, wherein the communication interface comprises at least one from among a Bluetooth interface or a Wi-Fi interface, and
wherein the third mode activates at least one from among the Bluetooth interface or the Wi-Fi interface.

18. The controlling method of claim 12, further comprising:
storing, based on a control command for image changing being received from an external device while operating in the third mode, the control command;
changing, based on the second time being reached in the third mode, the third mode to the first mode;
controlling the display to change the first image to a second image based on the control command in the first mode; and
changing from the first mode to the second mode or the third mode.

19. The controlling method of claim 12, wherein the electronic apparatus further includes a low-power timer, and
wherein the controlling method further comprises determining whether the first time and the second time are reached based on an output of the low-power timer.

20. A non-transitory computer-readable recording medium having one or more instructions recorded thereon, that, when executed by an electronic apparatus including a display and a communication interface individually or collectively, cause the electronic apparatus to:
control the display to display a first image in a first mode;
control, based on the first mode being changed to a second mode based on a first user input, the display to update the first image in the first mode after a first time; and
control, based on the first mode being changed to a third mode based on a second user input, the display to update the first image in the first mode after a second time,
wherein the communication interface is deactivated in the second mode, and activated in the third mode.
